(19) United States
(12) Patent Application Publication
(10) Pub. No.: US 2002/0026513 A1
(43) Pub. Date: Feb. 28, 2002

(54) Integrated real time and polled electronic messaging system and method

(76) Inventors: Robert Sargent Hoglund, Gurnee, IL (US); Donald M. Popowski, Crystal Lake, IL (US)

Correspondence Address: HALE & DORR LLP, THE WILLARD OFFICE BUILDING, 1455 PENNSYLVANIA AVE, NW, WASHINGTON, DC, 20004, US

(21) Appl. No.: 09/810,559

(22) Filed: Mar. 19, 2001

Related U.S. Application Data
(60) Provisional application No. 60/190,107, filed on Mar. 20, 2000.

(51) Int. Cl. G06F 15/16

(52) U.S. Cl. 709/227; 709/206

(57) ABSTRACT

A communications system for transmitting and/or receiving signals to/from at least a first communication device from/to at least a second communication device at least via a user specified real time and/or a polled transmission.

### RELATED APPLICATION

This application claims priority from U.S. provisional application serial No. 60/190,107 filed on Mar. 20, 2000 and entitled “Combined Agent And Messenger Process And System For Same”, the details of which are hereby incorporated by reference.

### BACKGROUND OF THE INVENTION

1. Field of the invention

The present invention relates generally to wireless messaging and, more particularly, to providing an integrated or combination real time and polled electronic messaging system, method and/or a computer readable medium storing computer-executable instructions for enabling e-mail messages and/or other data messages and/or services to be transmitted and/or received via a wireless communications device on either a real time and/or polled basis.

2. Background Description

FIGS. 1-3 show a prior art radio frequency (RF) transmission system 100, as disclosed in U.S. Pat. No. 5,819,172, incorporated herein by reference, for transmitting information from one of a plurality of originating processors A-N to at least one of a plurality of destination processors (A-N ) which may be transported during operation. The system 100 includes at least one gateway switch 150 that stores information received from one of the at least one originating processor prior to transmission of the information to the at least one destination processor; a RF information transmission network 130 for transmitting stored information received from one of the at least one gateway switch 150 by RF transmission to at least one destination processor; and at least one interface switch 162 that connects a gateway switch 150 to the RF transmission network 100 and transmits stored information received from one of the at least one gateway switch 150 to the RF information transmission network 100.

The information is transmitted to a receiving interface switch by the electronic mail system in response to an address of the receiving interface switch which has been added to the information originated by the originating processor by either the originating processor or gateway switch 14. The information is transmitted from the receiving interface switch to the RF information transmission network 130 with an address of the destination processor to receive the information which has been added by either the originating processor, a gateway switch or the receiving interface switch.

More particularly, FIG. 2 illustrates a block diagram of the connection between a plurality of gateway switches with mailboxes 150 in different electronic mail systems to the RF information transmission network 160. Multiple gateway switches with mailboxes 150 from a single electronic mail system 1-N may be connected to each interface switch 162 instead of the connection of a single gateway switch with a mailbox to a single interface switch as illustrated. A plurality of interface switches 162 connect information transmitted from at least one electronic mail system as illustrated in FIG. 1. Optionally, a plurality of electronic mail systems 1-N are connected to a data input port of the RF information transmission system which is preferably hub switch 116. The dotted line communication paths 163 illustrate optional information transmissions in which information from a plurality of different electronic mail systems is concentrated at a single interface switch 304. The dotted line communication paths 161 illustrate connections to additional gateway switches with mailboxes 150 within electronic mail systems 1-N.

The interface switches 162 function as a security check to determine that information transmissions originating from a gateway switch with mailbox 150 represent transmissions which should be coupled to a hub switch 116 of the RF information transmission network 160. The security check is performed by the interface switch 162 comparing the identification number of the RF receiver 119 which has been added by either an originating processor AN or a gateway switch with mailboxes 150 with permissible identification numbers or the interface switch performing the addition of the identification number.

The interface switch 162 also removes information added by the electronic mail system 1-N to the information originated by the originating processor A-N from the stored information received from one of the gateway switches 14, and adds information used by the RF information transmission network 130 during transmission of the information originated at the originating processor to a RF receiver 119 in the RF information transmission network 130 which receives the information and transfers it to the destination processor A-N. Additionally, the interface switch 162 encodes data, which is required to format the display of the cathode ray tube (CRT) of the destination processor for the electronic mail system to which the destination processor is connected, in the form of a character or characters which are decoded by either the RF receiver 119 or the destination processor A-N. This information is added in decoded form back to the information which is processed by the destination processor with a format of the electronic mail system to which the destination processor A-N is connected.

The interface switches 162 also function to store information which has been stored by at least one gateway switch 150 that is received from a plurality of originating processors, and assemble the information from a plurality of originating processors into a packet having a predetermined format and transmit the packet to the hub switch 116 within the RF information transmission network 160. The hub switch is the preferable node in the RF information transmission network to which communications from the gateway switches 150 should be transmitted as a consequence of it having jurisdiction over both local access and transport area (LATA) switches 150 and the local switches 112 in the RF information transmission network, which results in lesser network overhead.

The hub switch 116 receives the packet from the receiving interface switch 162 and disassembles the packet into information from the plurality of originating processors. The originating processors are either within a single electronic mail system such as system 1, or from a plurality of electronic mail systems, such as systems 1-N, or from outside of any electronic mail system from at least one additional processor 312 which is connected directly to interface switch 162 to originate information to be transmitted to a destination processor A-N in an electronic mail system as described below. The RF information transmission network 130 transmits the disassembled information from the hub switch 116, including the identification number of the RF receiver 119 transferring information, to the destination processor A-N to a local switch 112 storing the file identified by the identification number and any destination of the RF receiver in the RF information transmission network to which the information and identification number is to be transmitted by the RF information transmission network, and adds any destination of the RF receiver to the information. The RF information transmission network, in response to any added destination, transmits the information and identification number to the destination for RF broadcast to the RF receiver 119 for transfer to the destination processor A-N.

The information is transmitted to a receiving interface switch 162 from one or more gateway switches 150 by one or more electronic mail systems 1-N in response to an address of the receiving interface switch which has been added to the information originated by the originating processor by either the originating processor or gateway switch. The information is transmitted from the receiving interface switch 162 to the RF information transmission network with an address of the destination processor, such as a name of a user of the destination processor A-N, to receive the information which has been added by either the originating processor A-N, a gateway switch 150 or the receiving interface switch 304.

Preferably, the address of the receiving interface switch is a code word, such as “TF-MOBOX”, which is recognized throughout the electronic mail system when appended to information as directing the information to be transmitted to the interface switch 304. The address of the destination processor is preferably the identification number of the RF receiver 119 within the RF information transmission network 160. The address of the receiving interface switch may be added to the information originated by the originating processor, by a gateway switch 150 or by the originating processor A-N. The address of the receiving interface switch 162 may be added to the information by matching an identification of the destination processor A-N which may be the name of the individual utilizing the processor or some other information to add an address of an interface switch such as the aforementioned “TF-MOBOX” stored with the matched identification of the destination processor to the information as the address of the receiving interface switch.

Alternatively, the originating processor may be used to add the address of the receiving interface switch 150 by inputting the address of the receiving interface switch (TF-MOBOX) along with an identification of the destination processor A-N (name of recipient using the processor).

The originating processor A-N may also add the address of the receiving interface switch 162 by matching an identification of the destination processor (name of the user of the processor) with a stored identification of a destination processor and adding an address of the interface switch (TF-MOBOX) stored with the matched identification of the destination processor to the information as the address of the receiving interface switch.

The identification number may be added to the information originated by the originating processor or, alternatively, maybe added by the originating processor by matching an identification of the destination processor (the name of the user of the processor) with a stored identification of a destination processor (the authorized user of the destination processor) and adding an identification number stored with the matched identification of the destination processor to the information as the identification number of the RF receiver 119. Alternatively, the aforementioned matching process may be performed by either the gateway switch 150 or the interface switch 304. The additional processors 312 originates information from outside of any electronic mail system.

Processors 312 provide an address of at least one destination processor in an electronic mail system, such as the name of the user, to receive information transmitted by the RF information transmission system 160, or an identification number of the RF receiver 119 receiving information and transferring the information to the destination processor. The interface switch 162 which receives the information from each processor 312 adds information used by the RF information transmission network 130 during transmission of the information to the RF receiver 119 receiving the information in the same manner as described above with respect to the interface switch 304.

Processors 312 are only required to have a telephone modem and support programming to format information for RF transmission to a destination processor A-N within any one of one or more electronic mail systems 1-N. The processors 312 are not required to have the necessary electronic mail system software present in originating processors A-N or interconnections with an electronic mail system. As a result of the connection to the interface switch 304, information originating from the additional processors 312 may be transmitted by RF transmission to a destination processor A-N within any one or a plurality of electronic mail systems with the user of the processor 312, the processor 312 or the interface switch 162 only having to supply an identification number of the receiver 119 to input information into the RF information transmission system 130 for RF transmission to a destination processor.

The difference between originating information by one of the additional processors 312 outside of any electronic mail system and originating information by one of the processors within one of the electronic mail systems is that the direct connection of the additional processor to the interface switch 162 eliminates the requirement for the adding of an address of the interface switch 162 which is required by the electronic mail systems to forward the information to the interface switch where necessary formatting of the information to be compatible with the RF information transmission system is performed. The interface switch 162 packetizes information originating from the additional processors 312 in the same manner as described above with respect to information originating from within an electronic mail system.

Information from within an electronic mail system and originating from additional processors 312 outside of the electronic mail system may be formatted into the same packets which are forwarded to the hub switch 116. Additionally, interface switch 162 may be connected only to the additional processors 312 to provide an interface only for processors outside of any electronic mail system to destination processors A-N within one or more electronic mail systems 1-N. The only information which is necessary to be inputted by the additional processors 312 is the address of the destination processor (user of the processor). The addition of the identification number of the receiver 119 may be added by matching of an identification of the destination processor with stored destination processors within the additional processor 312, or the interface switch 162 with an identification number of the receiver 119 stored with an identification of a destination processor A-N used as an identification of the destination processor upon a match having been made.

Prior art FIGS. 1-3, however, do not generally relate to, for example, providing an integrated or combination real time and polled electronic messaging system, method and/or a computer readable medium storing computer-executable instructions for enabling e-mail messages and/or other data messages and/or services to be transmitted and/or received via a wireless communications device on either a real time and/or polled basis

In recent years, technological advance and consumer demand together have made wireless messaging and related services (e.g., eLink^{SM} provided by Motient Corporation, Reston, Va.) increasingly popular. These services allow users to, for example, send and receive e-mail messages, as well as provide other messaging services such as paging and faxing. Such e-mail messages are generally received on either a polled or real time basis, where the user has to select the preferred delivery method.

In a polled delivery scheme, the user's existing Internet e-mail account is “extended” via a wireless communications device. For example, in the case of eLink^{SM}, messages are retrieved from, for example, a Post Office Protocol 3 (POP3) or Internet Messaging Access Protocol 4 (IMAP4) server and forwarded to a user's wireless device. Using a wireless device, users can access their Internet mailbox either automatically by, for example, setting one or more times at which they wish to receive their messages, or manually by, for example, clicking a “Get Messages” or similar icon. Other ways of accessing the mailbox are also optionally possible. In a real time delivery scheme, user's are generally provided a new, unique e-mail address, which obviously provides the user with an e-mail account that is separate from their desktop e-mail account. For example, in the case of eLink^{SM}, user's are provided a unique e-mail address having the form <username>@2way.net. Other message forms and/or domain names may also optionally be utilized. Such wireless schemes also generally allow users to respond to e-mails in a way such that they appear as though they are originated from the user's e-mail system residing on their desktop PC.

However, when user's use a wireless device as an extension of, say, their personal or corporate desktop POP e-mail account, they generally do not have access to services such as faxing and paging. We have determined that introducing a POP3 and IMAP service within a real time delivery scheme, therefore, would advantageously allow users to send and/or receive both polled and/or real time messages.

We have also determined that a need exists for an integrated wireless communications system that allows users to send and/or receive messages on a real time and/or near real time basis via an e-mail or other data message account associated with a wireless communications device, while also allowing users to utilize the wireless communications device to check messages stored within, for example, a separate (POP or IMAP) e-mail or data message account associated with, for example, a personal or corporate e-mail account. The present invention fulfills this and other needs by providing an integrated wireless service system that enables e-mail or other data messages and/or other services, such as faxing and paging, to be transmitted and/or received from/to a wireless communications device on either a real time and/or polled basis.

### SUMMARY OF THE INVENTION

It is a feature and advantage of the present invention to utilize a wireless communications device to transmit and/or receive e-mail and/or other messages on a real time and/or polled basis.

It is another feature and advantage of the present invention to optionally allow users to utilize a wireless communications device to transmit and/or receive real time messages via an e-mail or other account associated with the wireless device.

It is yet another feature and advantage of the present invention to optionally allow users to utilize a wireless communications device to receive polled messages via an e-mail or other data account associated with a device other then the wireless device.

It is a further feature and advantage of the present invention to optionally utilize a wireless communications device in conjunction with the transmission and/or receipt of other wireless messaging services such as facsimile and numeric paging.

The present invention fulfills these and other needs by providing an integrated or combination wireless messaging service that allows users to transmit and/or receive e-mail and/or other messages on a real time basis or substantially real time basis via an e-mail or other account associated with a wireless communications device. The present invention also advantageously and optionally allows users to utilize the wireless communications device to check messages stored within, for example, a separate POP or IMAP e-mail or data account.

### Wireless-Wireless Transmission

In accordance with the invention, sending a message from one wireless device to another wireless device via the network is one option or form of messaging. The user inputs to his wireless device the destination address of a second device to send a message. The message is then transmitted, preferably via the Motient^{SM} network or other suitable network through a standard base station, a standard RF/RNC, and over to a standard controller such as ACE. Then, depending on what the address of the second device is, the message is transferred either to one of the messenger gateways or to the agent gateways. Specifically, in the case of peer-to-peer messaging (e.g., where the second (receiving) device has an address of the form <username>@2way.net or other predetermined address(es)), the message is preferably routed via a messenger gateway. However, an agent gateway can also be utilized depending on, for example, network congestion consideration. Once the message reaches either a messenger or agent gateway via the network, the message follows a reverse path through the network back to the receiving device, without going out over the Internet. If the message does not have an @2way.net address or other predetermined address, the message is routed through an agent gateway to the intended receiver.

### Transmission Via Desktop/Laptop

Another type of message that can be sent is one that is initiated from a desktop/laptop or similar e-mail system which is destined for a wireless device having an e-mail address of the form <username>@2way.net (e.g., a subscriber of the Motient^{SM} network). Such a message is routed via the Internet to the designated wireless device via a messenger gateway, an ACE 414, a RF/RNC 412, and a base station 410 which broadcasts the message to the wireless device. Optionally, direct connectivity to a messenger gateway is possible, thereby precluding the need to connect to the Internet. This option may be utilized by, for example, large organizations (e.g., corporate customers), although smaller organizations/clients and/or individual users may also desire and/or utilize this option. In the case of direct connectivity, the desktop computer is connected to a messenger gateway, preferably via a computer. The message is then routed to the intended wireless device via an ACE 414, a RF/RNC 412, and a base station 410. In a preferred embodiment, an @2way.net address is pre-programmed to go through a messenger gateway to an ACE 414, an RF/RNC 412, to a Base Station 410, and then back out to the device 402, 404, 406.

Both the agent gateway(s) and messenger gateway(s) preferably have a direct connection to the Internet. However, other embodiments in the present invention provide that the messenger gateway(s) and/or agent gateway(s) receive messages from other modules or components in the system. For example, the agent gateway(s) may have direct connectivity to the Internet and transfer messages to messenger gateway(s) and/or vice versa. Other standard RF system components may optionally be used in conjunction with, or instead of, the ACE 414, RF/RNC 412, and the like that are programmed with the functionality described herein.

### Transmission via Agent Gateway

Another example of a message transmission occurs when the message transmission path defaults to an agent gateway. In this example, a user's wireless device 402, 404, 406 is configured to poll an e-mail mailbox (e.g., POP or IMAP) associated with the user's desktop and/or laptop PC. The storage for the e-mail mailbox will generally, but does not have to, reside on a remote server. Such polling may occur manually (i.e., a user specifically perform one or more commands to retrieve messages), or automatically on a predetermined basis (e.g., every 30 minutes). The agent gateway preferably accesses the mailbox via a network such as the Internet, retrieves any message(s) therein, and temporarily stores the messages on the agent gateway or server associated therewith. The agent gateway then directs the messages to the wireless device that has the address associated with that mailbox via an ACE 414, a RF/RNC 412, and a base station 410. This addressing and mapping between the wireless device and the mailbox is preferably performed by the user by, for example, a user registration process and device via, for example, a web server.

### Combined Agent/Messenger Gateway Advantages

The agent gateways and/or messenger gateways thus allow a single user to hold more than one e-mail account, and access each of those accounts via a single wireless device, although other standard methods are additionally and optionally provided as well. For example, a user may have a personal and/or corporate POP and/or IMAP based account and a second account associated with the Motient^{SM} network having an @2way.net domain name. The combined system is capable of routing messages from the personal account to the network account. Similarly, in sending a message from a wireless device 402, 404, 406 via the network account, the user may use the agent gateway so that the message is not sent to the intended recipient immediately, but is polled. In this case, the sender is not particularly concerned that the recipient receives the message on a real time basis (i.e., as soon as possible). A user can also gain added flexibility by, for example, giving his network account to whom he wishes to receive message from as soon as possible, and give his POP or IMAP e-mail account to those whom he does not need to receive messages from on a real time or near real time basis.

The invention thus advantageously provides the additional optional ability to not be interrupted, for example, in a meeting. That is, the user can set filters associated with polling of the agent gateway in a manner such that he does not receive any messages therefrom unless the user, for example, manually queries an agent gateway. Alternatively, the user may set a filter such that the wireless device automatically polls an agent gateway at a particular time or times during the day (e.g., 9:00 AM and/or 5:00 PM and/or every 30 minutes). If the user sets the filters such that he must manually poll an agent gateway to receive messages therefrom, if he is in a meeting then he knows that any messages he receives on the wireless device are coming via a messenger gateway (e.g., the message has an address of the form <username>@2way.net), and not something that was sent to his POP and/or IMAP desktop e-mail or other message account that has been forwarded to him. Thus, a user can provide his <username>@2way.net or other predefined account to people, for example, to whom he tells to not send him an e-mail at this address unless you really need to contact me for something very urgent.

There are also many reasons why a corporation or other organization may want to provide separate e-mail accounts and/or a wireless device (e.g., a corporate POP or IMAP account and/or an account associated with the wireless device). A corporation may give an employee a wireless device so that he can check and/or use his personal and/or corporate POP or IMAP e-mail account(s) when he is on business travel. Alternatively, if desired, a wireless device may be provided as the only and/or primary corporate e-mail account.

Thus, the combined agent and messenger system provides a wireless messaging system that affords users the opportunity to, for example, check personal and/or corporate POP or IMAP e-mail accounts whenever the user desires via the wireless device, as well as receive messages associated with an e-mail address of the wireless device on a real time or substantial real time basis. The system according to the present invention also provides users additional flexibility in how they want to manager their messages in, for example, a corporate or other meeting, as discussed above.

### Paging Functionality

The paging functionality of the present invention preferably operates in a similar manner. Depending on the way the page is set up, a messenger gateway preferably associates the page with an e-mail address of a wireless device 402, 404, 406. The data message is preferably generated from a standard numeric paging system. When that message is transmitted to a messenger gateway, the page message looks like an e-mail message that is addressed to, for example, a device that utilizes an address of the form <username>@2way.net. The text of that message will be the numbers that were keyed through the numeric paging system.

### Facsimile Functionality

Advantageously, one embodiment of the present invention also provides a facsimile and paging capability that is possible via the agent gateway which was not before possible. By connecting the agent and messenger gateways together, now a facsimile may be sent to a device that had an address previously associated with an agent gateway (i.e., an address that does not have an address of the form <username>@2way.net), via a messenger gateway, as discussed below in greater detail.

From a functional standpoint, the capability of the agent gateways, which are polling based, are advantageously combined with the direct (real time or near real time) e-mail, facsimile and paging capabilities of the messenger gateways. The messenger gateway facsimile and paging functions may also be utilized via the agent and messenger gateway combinations. Optionally, multiple agent gateways and/or multiple messenger gateways may be utilized, as discussed below in greater detail.

### SUMMARY OF PREFERRED EMBODIMENTS

At least some embodiments according to the present invention contemplate a communications system for transmitting and/or receiving signals with at least two communication devices via a real time and/or a polled transmission. The system includes at least one first gateway responsively communicable with at least a first communications device and at least a second communications device. The first gateway transmits and/or receives signals on a real time basis with the first communications device and the second communications device. The second gateway is responsively communicable with the first communications device and a least a third communications device, and transmits and/or and receives signals on a polled basis with the first communications device and the third communications device. In general, the first gateway and the second gateway are operatively connectable to each other to perform the real time and the polled transmission based upon predetermined criteria, such as an Internet domain name.

The first and second communication devices optionally comprise wireless messaging devices that have an identifier associated with the first gateway, and transmit/receive signals/messages to each other via the first gateway. Alternatively, or in addition, the first communications device can be a wireless messaging device having a first identifier associated with the first gateway, and the third communications device can be an e-mail server storing messages for at least one e-mail account, each e-mail account having a second identifier associated therewith. In this embodiment, the first communications device and the third communications device can transmit signals to each other via the first and second gateways.

The system can also include a selection system that allows a user to select either real time and/or polled transmission. When a polled transmission is selected, the signals comprise at least one e-mail message that is retrieved from a specified e-mail account associated with the third communications device and are transmitted to the requesting first communications device.

The second gateway preferably comprises a scheduler that determines which of the first communication devices are active, and a device action manager that receives notification from the scheduler and monitors which of the first communication devices have requested to download a message. A download manager receives notification, via said scheduler, at which time messages associated with each of the first communications device are to be downloaded. A message lookup manager determines an identifier associated with each message associated with each of the first communications devices and selects those messages that have not been downloaded from the third communications device to the first communications device. A message processor retrieves messages not yet downloaded from the third communications device and transmits the messages to a designated first communications device as determined by the registration system.

The scheduler can optionally determine the time at which each of the first communications device are to receive a message and/or access subscriber information from the registration system to determine user specified download times. The download manager can optionally download messages subsequent to receiving an indication from the scheduler and lookup manager. The message processor can convert the message format of the third communications device to a message format of the first communications device, whereas the lookup manager can delete message records when corresponding messages are deleted on the third communications device. Each of the first gateways preferably have a common identifier (e.g., Internet domain name) associated therewith.

A preferred method according to the present invention pertains to transmitting and/or receiving signals with at least two communication devices via a real time and/or a polled transmission. The preferred steps include a) determining based upon predetermined criteria whether the signals are to be transmitted in real time or on a polled basis; and b) transmitting, upon determining that the signals are to be transmitted in real time, the signals from a first communications device to a second communications device via either a first gateway or a second gateway, and transmitting, upon determining that the signals are to be transmitted on a polled basis, the signals from a third communications device to the first communications device via the first gateway and the second gateway.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

### BRIEF DESCRIPTION OF THE DRAWINGS

The Detailed Description including the description of a preferred structure as embodying features of the invention will be best understood when read in reference to the accompanying figures wherein:

FIG. 1 illustrates a prior art block diagram of a known messaging system;

FIG. 2 illustrates a prior art block diagram of the connection of a plurality of electronic mail systems through a plurality of interface switches to an input port of an RF information transmission network;

FIG. 3 illustrates a prior art block diagram of the transmission of information originating from a plurality of electronic mail systems to an RF information transmission network to a plurality of destination processors and originating processors within a plurality of electronic mail systems;

FIG. 4 is a schematically simplified representation of the Motient^{SM} terrestrial communications network;

FIG. 5 is a simplified block diagram of the combined agent/messenger system;

FIG. 6A is a simplified representation of the Post Office Protocol (POP) software architecture according to the present invention;

FIG. 6B is a detailed representation of the POP software architecture according to the present invention;

FIG. 7 is a block diagram of the combined agent/messenger system and POP software architecture;

FIG. 8 is a high level flow diagram of a preferred method in accordance with the invention; and

FIG. 9 is a more detailed flow diagram of a preferred method in accordance with the invention.

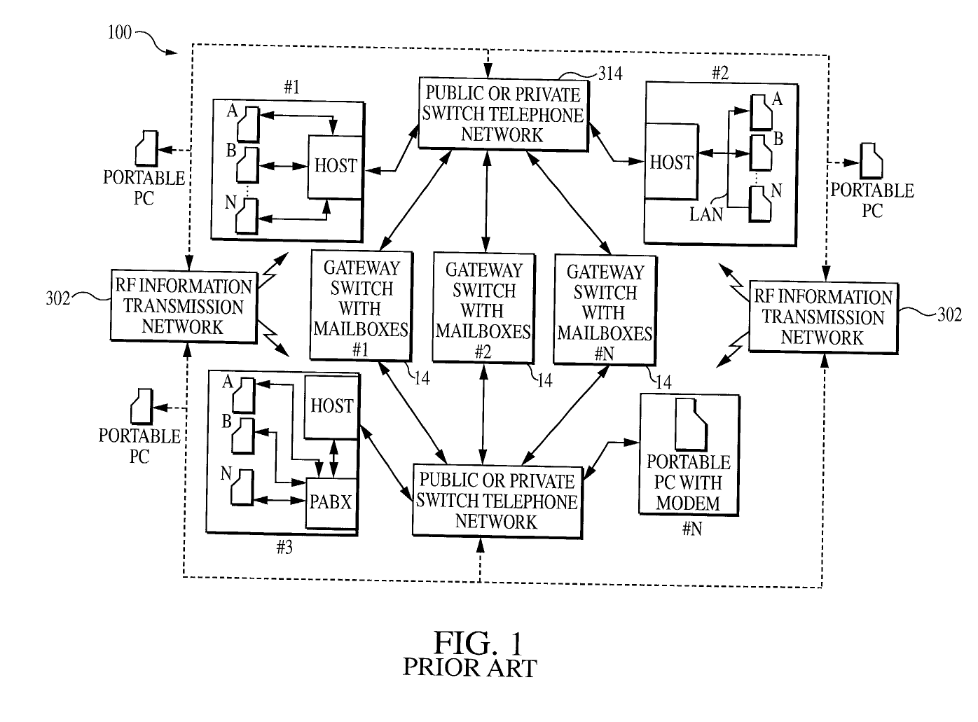

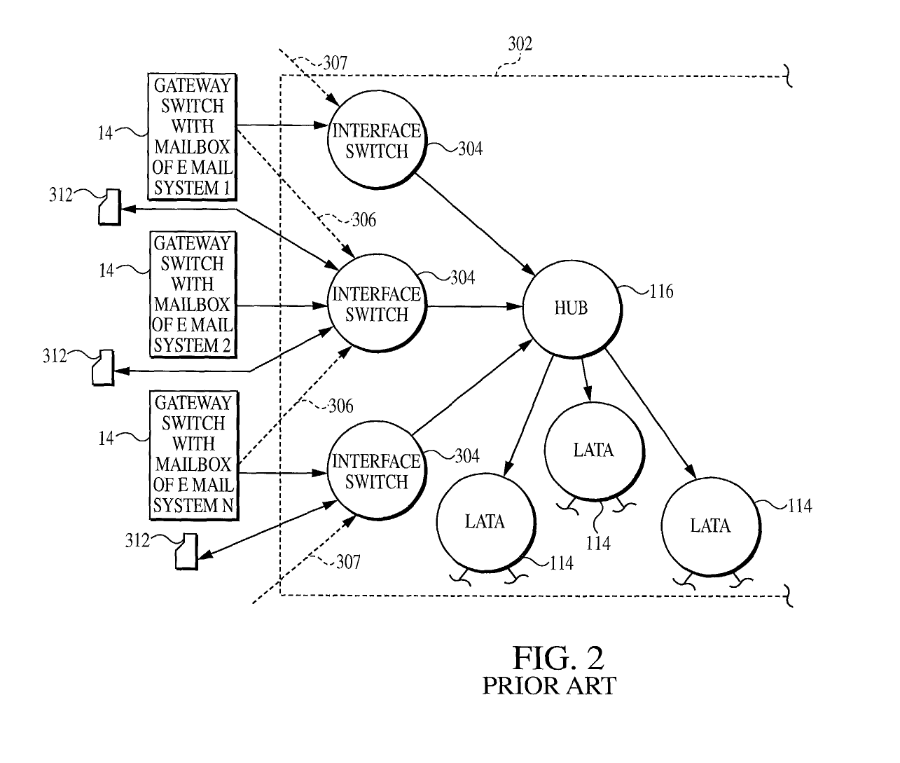

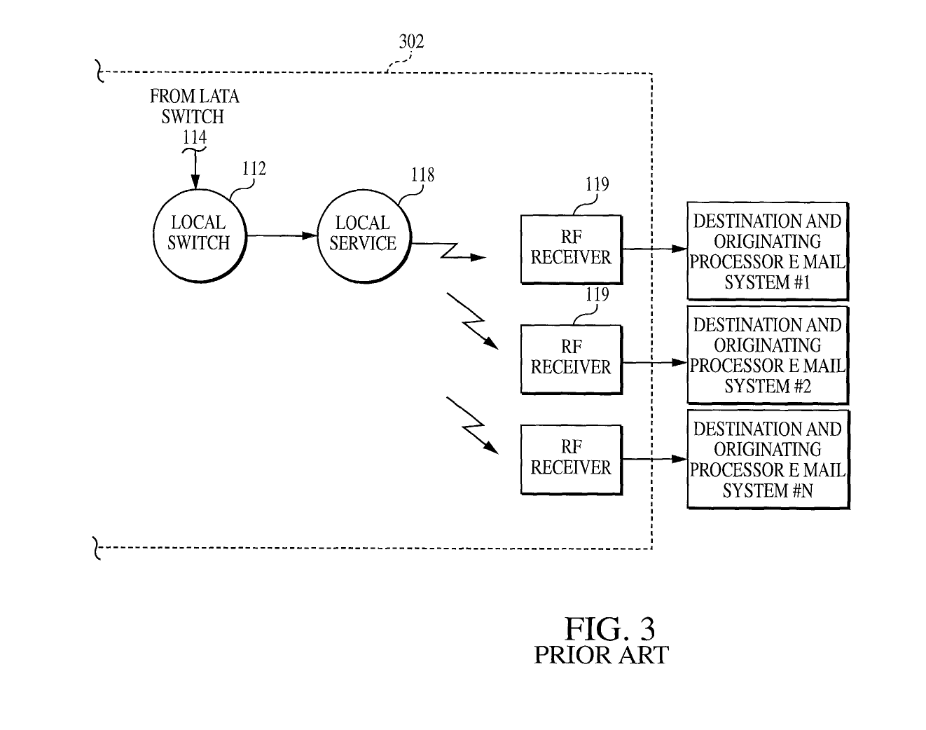

### DETAILED DESCRIPTION OF A PREFERRED EMBODIMENT OF THE INVENTION

### The Motient^{SM} Network

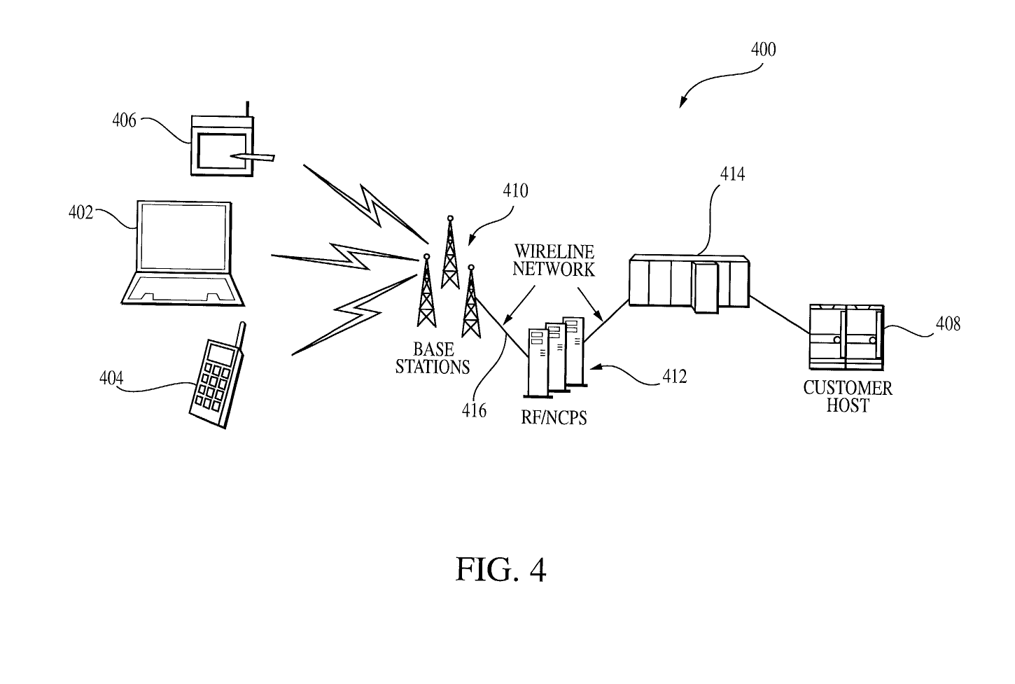

A general description of the Motient^{SM} wireless messaging network 400, which provides either the polled or real time message delivery for an individual wireless device, is now described and illustrated in FIG. 4. The network 400 is a terrestrial wireless two-way data network that allows wireless devices such as an intelligent terminal or computing device 402, handheld device 404, or other wireless communications device 106 to communicate with their respective host computer 408 and each other. Wireless devices 402, 404, 406, therefore, typically have a radio frequency (RF) modem for sending and receiving signals.

The network 400 has over 1750 base stations (410) providing service to cities and towns throughout the United States, Puerto Rico, and U.S. Virgin Islands. Each base station 410 covers a radius of approximately 15-20 miles. The base stations 410 are radio frequency towers that transmit or receive radio signals between wireless devices 402, 404, 406 and the Radio Frequency/Network Control Processors (RF/NCPs) 412. Base stations 410 transmit and receive radio signals, preferably using a narrow band FM transmitter and receiver operating in the 800 MHz frequency band. There are separate frequencies for the transmit path and the receive path; together these two frequencies represent a full duplex channel that normally transmits data at 4800 bps in both directions. In operation, for a message “inbound” to the network 400 from a wireless device 402, 404, 406, the signal is “heard” by the base stations 410 and sent over a phone line 416 to a RF/NCP 412. The network 400 employs an automated roaming capability that allows the free movement of wireless devices 402, 404, 406 between cities and between multiple channels within a given city. This capability allows the wireless devices 402, 404, 406 to freely move (roam) across the country and take advantage of all the network 400 services that are available in every locale.

The RF/NCPs 412 are high-speed computers that interconnect multiple base stations 410 with the ARDIS® Connect Engine(s) (ACEs) 414. A number of RF/NCPs 412 are located together serving a particular geographical area, each being connected by high speed digital phone service to one of the ACEs 414, which route messages to a destination such as a customer host computer 408 that is connected to the network 400 by, for example, a leased telephone line or a value added network. RF/NCPs 412 pass information relating to source, destination and length of each message to an ACE 414 that enables the network 400 to do network analysis of, for example, traffic density in each city. An ACE 414, in turn, passes information back to a RF/NCP 412 concerning whether the wireless device 402, 404, 406 is properly registered to the network 400 and, if so, what level of service of provided to the respective subscriber 402, 404, 406. The RF/NCPs also help manage the roaming capability of the network 400. Wireless devices 402, 404, 406 can automatically move (roam) between any of the network 400 frequencies on either of the two protocols (MDC 4800 and RD-LAP 19.2), or between any of the configured network 400 layers that have been configured for in-building or on-street usage.

The ACEs 414 are general purpose computers that act as the heart of the network 400. The ACEs 414 route messages to the proper destination, store subscribe registration information including entitlement, and perform accounting and billing functions. The ACEs 414 also serve as a point of connectivity to customer host computers 408, perform protocol conversion, and perform network 400 troubleshooting and test functions. A plurality of ACEs 414 are interconnected through dedicated leased lines, with alternate paths available from each switch as a contingency measure against line interruptions.

The wireline network 416 provides communication between the customer host computers 408, the ACEs 414, the RF/NCPs 412, and the base stations 410. The wireline network 416 is equipped with sophisticated communications equipment that relays customer messages. This equipment includes intelligent multiplexers, leased telephone circuits, high-speed modems or digital service units, and modems for both RF/NCP 412 and customer host computer 408 connectivity.

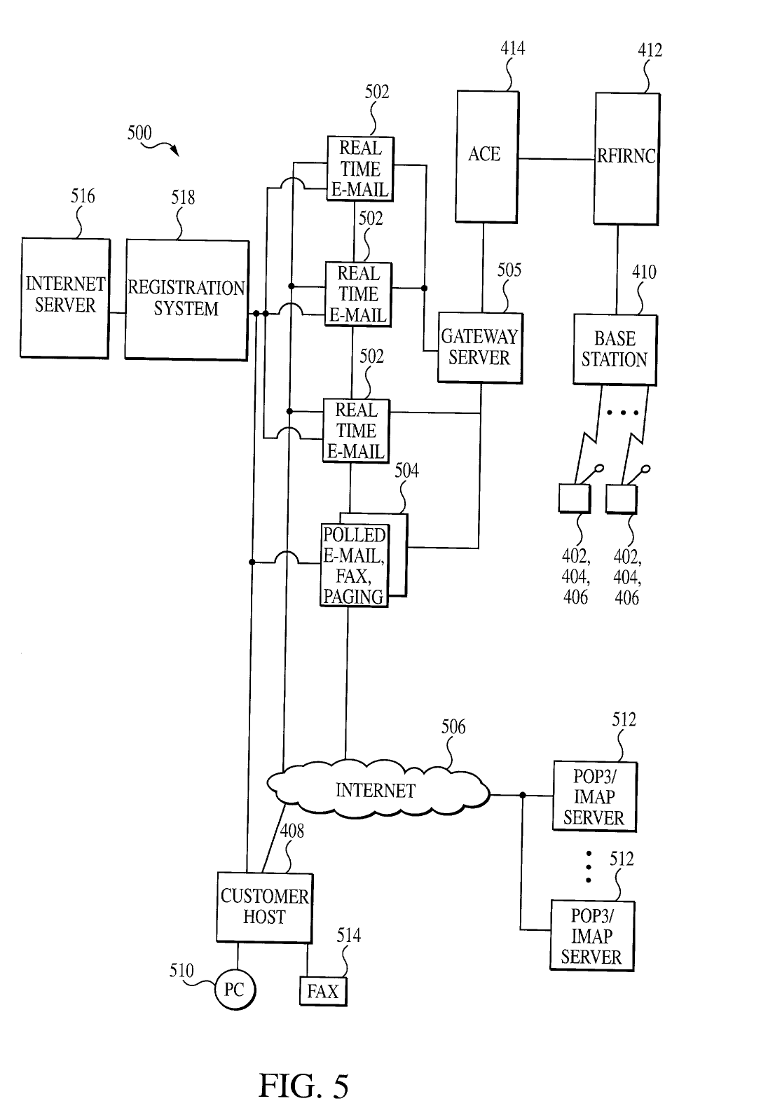

Referring now to FIG. 5, the combined agent/messenger gateway system 500 is shown. The wireless devices 402, 404, 406, the base station(s) 410, the RF/RNC(s) 412, the ACE(s) 414, and the customer host(s) 408 are each as described in the Motient^{SM} network described in FIG. 4. In addition, a plurality of messenger gateways 502 and agent gateways 504 are shown. In general, there can be one or more messenger gateways 502 and one or more agent gateways 504. The messenger 502 and agent 504 gateways are each connected, directly or optionally indirectly via, for example a gateway server 505, to an ACE 414. The gateways 502, 504 are also connected to a network 506 such as the Internet, and a registration system 518. The registration system 518 contains the required profile for each user, as will be explained in further detail herein, and is preferably connected to an Internet server, which allows users to optionally modify user information such as times at which they wish their wireless device 402, 404, 406 to retrieve messages from a server 512. One or more customer host computers 408 are connected to the Internet, and may optionally be connected to a messenger gateway 502. Finally, one or more e-mail servers 512 are connected to the Internet 506.

One optional difference between the messenger gateways 502 and the agent gateways 504 lies with the addressing scheme. The messenger gateways 502 (and wireless devices 402, 404, 406 associated therewith) operate with their own unique Internet domain name, comprised of at least an organization's or an individual's name combined with a top level domain name. Top level domain names can include: a) .com; b) .net; c) .org; d) .edu; e) .gov; f) .mil; and g) .int. Other top level domain names can also be used as they become available (e.g., firm, store, arts, etc).

In a preferred embodiment, the domain name is @2way.net, although it will be readily recognized that domain names other than @2way.net can optionally be used. The end user has the option of what the <username> portion of the <username>@2way.net address will be, and can preferably change the <username> portion at any time in the registration system 518 via Internet server 516. The messenger gateways 502 thus preferably perform operations on messages having a domain name associated with the system 500 (e.g., in the case of the Motient^{SM} network 400, an @2way.net domain name), whereas the agent gateways 504 preferably perform operations on messages having any domain name. Other methods of altering the functionality are also possible. For example, the functionality can be optionally distributed among the agent 504 and messenger 502 gateways as well.

The system 500 provides a wide variety of messaging services. For example, the messenger gateways 502 offer the power of two-way e-mail messaging, as well as optional facsimile (fax) and paging capabilities. Users can thus send messages to, for example, other wireless devices 402, 404, 406, to PC's 510 or similar devices via the Internet 506, as well as a text message to a fax machine 514. In a preferred embodiment, a wireless device such as a RIM™ 850 model wireless handheld device will be utilized, which can also receive and/or transmit pages via the network 500.

In a preferred embodiment, users who may use, for example, a POP and/or IMAP e-mail account(s) residing on, for example, a desktop/laptop PC 510 as their primary desktop e-mail are provided the convenience of utilizing a wireless device 402, 404, 406 to check their PC 510 account messages as will be discussed in further detail. The agent gateways 504 in conjunction with wireless devices 402, 404, 406 thus operate as an “extension” of, for example, a user's personal and/or corporate e-mail address/account. The agent gateways 504 preferably operate on a polled basis, checking, for example, a user's personal and/or corporate e-mail account when a user manually makes a request or automatically on a predetermined automatic basis (e.g., every 60 minutes).

### Messaging Between Wireless Devices

The operation of the system 500 can be best described and illustrated by providing several examples. The system 500 can, for example, be used to send a message from one wireless device 402, 404, 406 to another wireless device 402, 404, 406. Although only two subscriber devices 402, 404, 406, are explicitly shown, any number consistent with network 500 capacity may be provided. The user inputs to his wireless device 402, 404, 406 the destination address of a second wireless device 402, 404, 406 to which he wishes to send a message. The message is then transmitted via a RF transmission to base station 410. Once received at a base station 410, the, message is preferably transmitted via a wireline network to a RF/RNC 412, and then preferably transmitted to an ACE 414. At this point, depending on what the recipient's address is, the message is then routed, via a gateway server 505, to either a messenger gateway 502 or an agent gateway 504. It should be understood, however, that the base stations 410, RF/RNCs 412 and ACEs 414 are not required, as such, to practice the invention. That is, any suitable transmission path and/or means for transmitting that enables the RF signals emitted by the wireless devices 402, 404, 406 to reach a messenger gateway 502 and/or agent gateway 504, or equivalents thereof, is all that is required.

In the case of peer-to-peer messaging (i.e., where the originator and recipient of the message both subscribe to a same network such as the Motient^{SM} network 400), the message is advantageously routed to either a messenger gateway 502 or an agent gateway 504, without any substantial delay. Such a determination will generally be made by considering factors such as network traffic and loading of the respective gateways. Once received at either a messenger 502 or agent 504 gateway, the message is “turned around”, without being routed through the Internet 506, and routed back through a gateway server 505, an ACE 414, an RF/RNC 412, a base station 410, and finally to a recipient wireless device 402, 404, 406.

### Desktop to Wireless Device Messaging

Another type of message that can be transmitted by the system 500 is one that is initiated from a desktop e-mail system such as a PC 510, and destined for a wireless device 402, 404, 406. If the wireless device 402, 404, 406 has an @2way.net domain name, the message is routed over the Internet 508 to the wireless device 402, 404, 406 via a messenger gateway 502, gateway server 505, an ACE 414, a RF/RNC 412, and a base station 410. Optionally, direct connectivity of, for example, a customer host 408 to a messenger gateway 502 is possible. Here, the message is routed from the user's PC 510 via a customer host 408 to a messenger gateway 502, a gateway server 505, and then out through an ACE 414, a RF/RNC 412, and base station 410 for broadcasting to the wireless device 402, 404, 406. With either a standard transmission via a network such as the Internet 506 or via direct connectivity to a messenger gateway 502, the transmission path to a messenger gateway 502 is based on the fact that the message has been addressed to a predetermined address, e.g., <username>@2way.net address, which is the domain for the messenger gateways 502. Thus, in a preferred embodiment, an address originating from, say, a PC 510 and destined for a recipient having an e-mail address of the form <username>@2way.net address will be transmitted from the PC 510, through a messenger gateway 502, a gateway server 505, an ACE switch 414, a RF/RNC 412, a base station 410, and finally to the designated wireless device 402, 404, 406.

As previously noted, both the agent gateways 504 and the messenger gateways 502 advantageously have direct connection to the Internet 506. However, other embodiments in the present invention provide that the messenger gateways 502 and/or agent gateways 504 receive the messages from other modules or components in the system. For example, an agent gateway 504 may have direct connectivity to the Internet 506 and transfer messages to a messenger gateway 502, and/or vice versa.

### Retrieving Messages from Another Account

Another example of a message transmission involves the use of a wireless device 402, 404, 406 to retrieve messages from, for example, a user's POP3 and/or IMAP 4 e-mail account residing on, say, a PC 510. Here, the wireless device 402, 404, 406 is preferably configured to poll the user's e-mail mailbox residing on, for example, a POP and/or IMAP server 512 at a fixed time or time interval (e.g., 5:00 P.M. and/or every 35 minutes). Alternatively, the wireless device can poll the user's server 512 when manually directed to so by the user by, for example, clicking a “Get Mail” icon. In either case, an agent gateway 504 can access the user's mailbox residing on a server 512 via a network such as the Internet 506, pull any message therein, and store them on an agent gateway 504. The messages can then routed via gateway server 505 to an ACE 414, a RF/RNC 412, a base station 410, and then to the user's wireless device 402, 404, 406 that has the address associate with that particular mailbox. This addressing and mapping of the user's wireless device 402, 404, 406 to the user's POP and/or IMAP e-mail account(s) is preferably done through the registration system 518, which contains the required profile for each user.

The agent gateways 504 thus merge a user's Internet 504 e-mail mailbox residing on a server 512 with the wireless device 402, 404, 406 to retrieve, either automatically on a predetermined basis or manually as directed by the user, mail from the user's POP and/or IMAP e-mail account(s). The agent gateway 504 thus enables a user to utilize the same e-mail address as their POP and/or IMAP e-mail account. This also allows a user to, for example, respond to received e-mail messages from their wireless device 402, 404, 406 such that the messages look like they are being sent from the user's PC 510. In a preferred embodiment, any messages sent from a wireless device 402, 404, 406 are duplicated into a user's “Sent Mail” folder on server 512 when using the IMAP.

The system 500 allows users to have, for example, two e-mail accounts: one that utilizes a messenger gateway 502 to send and receive messages substantially immediately, and one that utilizes an agent gateway 504 for sending and receiving messages on a polled basis. The user can provide e-mail addresses associated with the respective accounts to various people, thereby providing enhanced flexibility as to how soon messages are received. Optionally, the agent gateways 504 and/or messenger gateways 502 allow a single user to hold two or more e-mail accounts (e.g., a work account and/or a personal account), and route e-mail from both either or both accounts to a single wireless device 402, 404, 406.

Having these two e-mail addresses allows a user, for example, to not be interrupted by messages coming through an agent gateway 504. This feature is provided by allowing the user to optionally and advantageously select when he wants to receive his messages. For example, the user can specify that he only wants to receive messages, for example, when he logs on and downloads them, or at a particular time (e.g., 5:00 P.M.). In such a case then, if the user is in a meeting at 2:00 P.M., he would then know that the message he has received is a message sent via a messenger gateway 502.

In a corporate setting, an employee who has a wireless device 402, 404, 406 and does not want, need, or currently have access to a corporate e-mail account can utilize the wireless device 402, 404, 406 in conjunction with his home e-mail system. Alternatively, employees who are away from the office may use a wireless device 402, 404, 406 to receive messages via a messenger gateway 502, particularly if they do not have either a home or work e-mail account from which they can retrieve their messages via an agent gateway 504.

### Paging Service

The paging service operates in manner similar to the e-mail service. As previously noted, it is preferred that a wireless device such as a RIM™ 850 model be utilized, which can also receive and/or transmit pages via the network 500. Thus, depending on whether the user, via the registration system 518, sets the page up to utilize an agent gateway 504 or a messenger gateway 502, the user can receive pages on either a real time or polled basis. Specifically, if the user chooses via the registration system 518 to have page messages utilize a messenger gateway 502, the user will receive pages via the wireless device 402, 404, 406 on a real time basis. Similarly, if the user chooses via the registration system to have page messages utilize an agent gateway 504, the user will receive pages on a polled basis, as determined by the user.

In a preferred embodiment, a page intended for a wireless device 402, 404, 406 is generated from a standard numeric paging system such that when that message goes out to either the messenger gateway 502 or agent gateway 504, the page message looks like an e-mail message that is addressed to a wireless device 402, 404, 406 having an address of the form <username>@2way.net domain name. The text of the message will be the numbers that were keyed through the numeric paging system.

### Facsimile Service Via Agent Gateway

Advantageously, the present invention, in accordance with one embodiment, enables a user to transmit a facsimile from a wireless device 402, 404, 406 to a facsimile device 514. By connecting the agent 504 and messenger 504 gateways together, a facsimile message can be transmitted from a wireless device 402, 404, 406 to a facsimile device 514 via a transmission path that includes a messenger gateway 502 (which does not have a faxing capability) and an agent gateway 504 (which does have a faxing capability). Previously, if an agent gateway 504 was not connected to a messenger gateway 502, a fax could not have been transmitted from a wireless device 402, 404, 406 via an agent gateway 502, since messenger gateways 502 do not have a faxing capability. From a functional standpoint, the capability of the agent gateways 504, which are polling gateways that include functionality that enable facsimile transmissions, are advantageously combined with the messenger gateways 502 used by wireless devices 402, 404, 406.

In operation, a wireless device 402, 404, 406, originates a facsimile message for a device 514. When a phone number for the facsimile device 514 is entered in the wireless device 402, 404, 406, the message is transmitted to a base station, an RF/RNC 412, an ACE 414, and subsequently to a messenger gateway 502. Since messenger gateways 502 do not have facsimile functionality, messenger gateways 502, which are operatively communicable with an agent gateway 504, transmit the facsimile message to an agent gateway 504. An agent gateway 504 then transmits the facsimile message to the facsimile device 514 via, for example the Internet 506. The facsimile transmission path can optionally include, for example, a customer host 408.

### POP Service

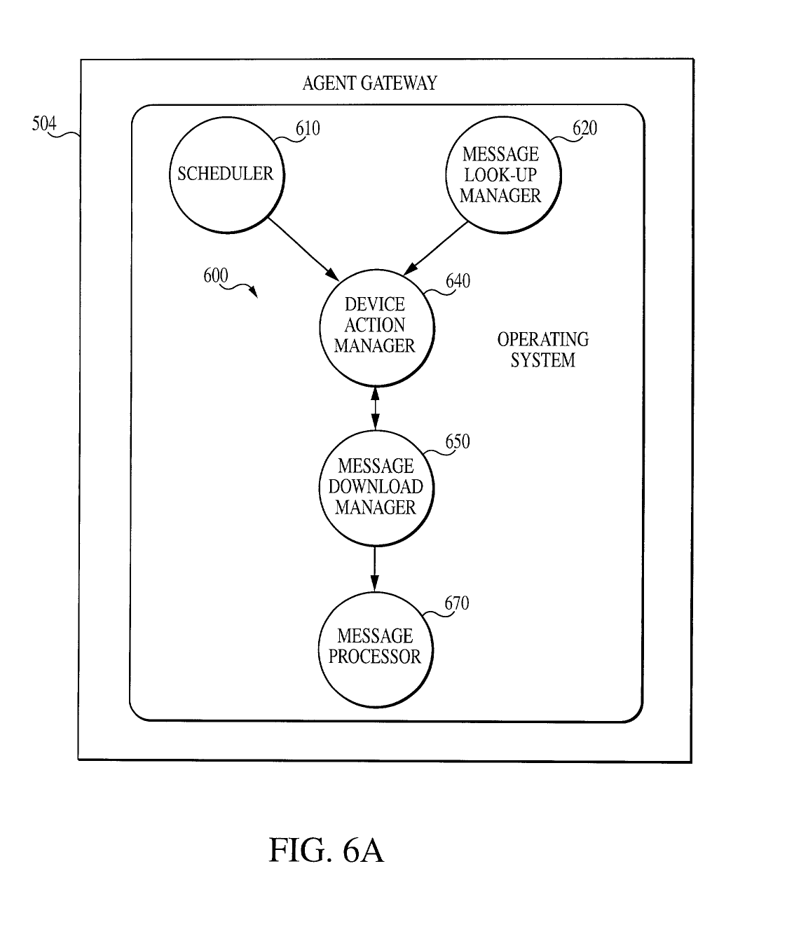

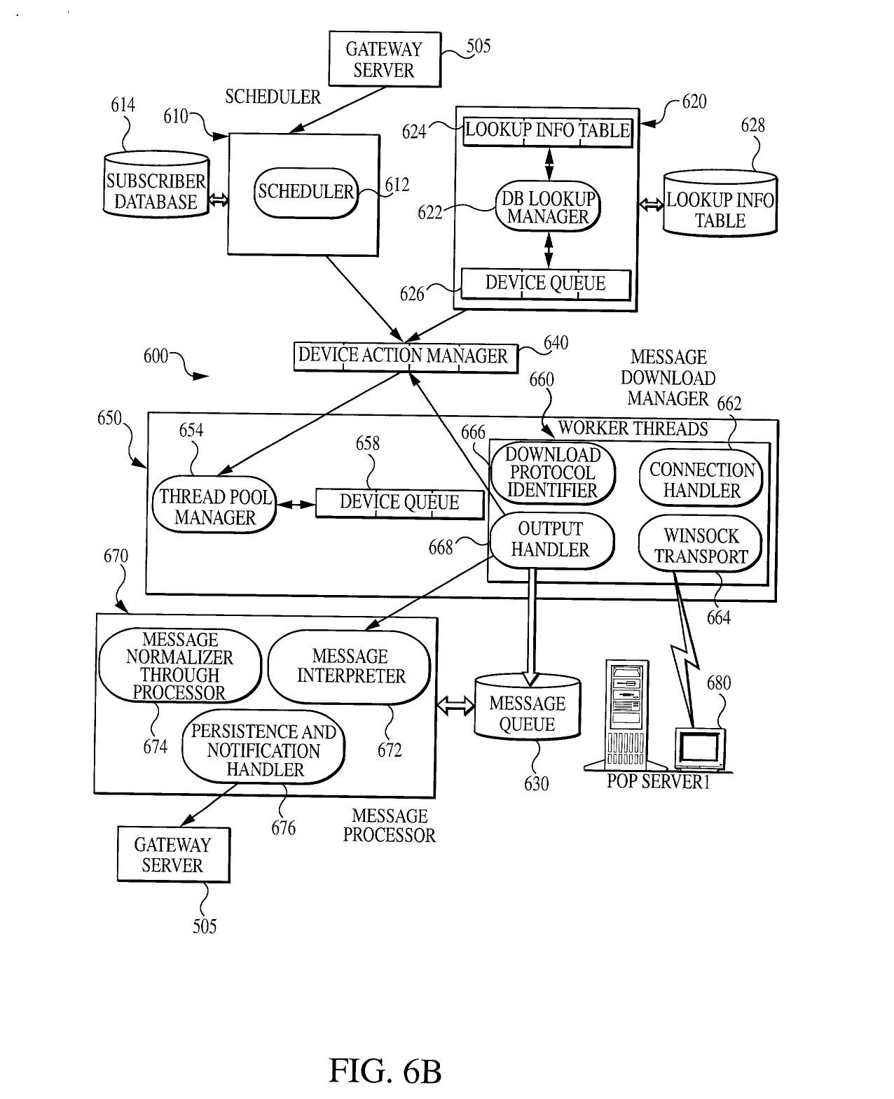

Turning now to FIG. 6A, a preferred high level embodiment of proxy server architecture 600, utilized in conjunction with the proxy server 505, is shown. The architecture 600 preferably works with at least POP and/or IMAP protocols. It should also be understood that the architecture 600 can accommodate both present and future version of the POP and IMAP protocols, as well as newly developed protocols used in transmitting and/or receiving e-mail and/or other wireless and/or electronic messages.

The scheduler 610 determines which, if any, of the wireless devices 402, 404, 406 are active. The scheduler 610 also, via the registration system 518, determines when each particular wireless device 402, 404, 406 registered with the system 500 is set to retrieve messages from an e-mail server 512. That is, the user may specify, via the registration system 518, that his messages be downloaded to his wireless device 402, 404, 406 on either a manual basis (e.g., a user specifically perform one or more commands to retrieve messages), or automatically on a predetermined basis (e.g., every 30 minutes). In the case of retrieving messages on a predetermined basis, the user optionally sets the time(s) at which he wishes his messages to be retrieved via the registration system 518. The user may change these settings at any time so that messages, for example, are retrieved at different times and/or time intervals, or retrieved manually.

In operation, the scheduler 610 notifies the download manager 620 via the device action manager 640 at the proper time for each wireless device 402, 404, 406. The scheduler 610 preferably accesses subscriber information to determine, for example, user specified download time(s) for each respective wireless device 402, 404, 406. Once the action for a particular user(s) is determined, the scheduler 610 notifies the device action manager 640.

The message lookup manager 620 is preferably optimized for downloading messages from a server 512 for worst case scenarios (e.g., 1000 messages in mailbox on server 512 with only one being a new message that needs to be downloaded). In a preferred embodiment, an identifier is associated with each user (e.g., a user ID), and a message identifier identifies each message (which is unique across various sessions for a given user) for each user that has been downloaded. The lookup manager 620 is also responsible for deleting records when corresponding messages are deleted from the user's mailbox storage on server 512.

In a preferred embodiment, the lookup manager 620 will access, for example, a message ID associated with each user message stored on an e-mail server 512. Each message ID associated with each user ID is unique. That is, the combination of the user ID and the message ID is preferably unique. Other unique identification systems or techniques may alternatively be used for the messages to be sent to specific individuals. Alternatively, or in combination, non-unique identifiers may be used. The lookup manager 620 accesses the message IDs associated with each message on an e-mail server 512, compares those IDs with the ID's of messages that have already been downloaded to the Proxy server 505, and downloads only those messages associated with message IDs that have not already been downloaded. In an alternative embodiment, when using IMAP, the lookup manager may simply access the last message ID downloaded and, in accordance with the IMAP, download from an e-mail server 512 those messages having a higher message ID number than the last message ID number downloaded. If desired, lower numbers can also be utilized to identify messages that have not been downloaded.

The message download manager 650 downloads new messages from servers 512 once new messages have been identified by the lookup manager 620. The download manager 650 waits for notifications from the scheduler 610 and the lookup manager 620.

The message processor 670 retrieves raw (i.e., messages in server 512 format such as POP or IMAP) messages, interprets the message format received from the server 512 mail format (e.g., POP, IMAP, etc.), and normalizes that message format to the Proxy server 505 message format, and stores the message(s) for subsequent processing. After storing the message, the gateway server 505 is notified to take action to transmit the message to the designated wireless device 402, 404, 406.

Turning now to FIG. 6B, a more detailed embodiment of the POP service architecture 600 is shown. Since the architecture 600 in accordance with the present invention potentially serves a large number of clients at any given time, there will generally be any number of servers 512. The servers 512 are preferably either POP and/or IMAP based servers, or other suitable hardware and/or protocol based system.

Since there may be a large number servers 512 and concurrent connections thereto, volume handling and scalability are important design criteria. Such volume handling and scalability are preferably addressed by providing a scheduler 610 that has a scheduling algorithm. The scheduler 610 determines which, if any, of the wireless devices 402, 404, 406 are active. Wireless devices 402, 404, 406 may be inactive for the obvious reason that they are not activated (e.g., turned off), or because they, for example, are in a designated coverage zone but cannot connect to the system 500 because of a building or other obstruction that prevents a RF signal of the wireless device from establishing contact with a base station 410. For wireless devices 402, 404, 406 to be active, they must be “connected” to the system 500 in the sense that they are able to send and/or receive messages thereto and/or therefrom.

As previously discussed, the scheduler 610 also, via the registration system 518, determines when each particular wireless device 402, 404, 406 registered with the system 500 is set to retrieve messages from an e-mail server 512. That is, the user may specify, via the registration system 518, that his messages be downloaded to his wireless device 402, 404, 406 on either a manual basis (e.g., a user specifically perform one or more commands to retrieve messages), and/or automatically on a predetermined or real time basis (e.g., every 30 minutes). In the case of retrieving messages on a predetermined basis, the user optionally sets the time(s) at which he wishes his messages to be retrieved via the registration system 518. The user may change these settings at any time so that messages, for example, are retrieved at different times and/or time intervals, or retrieved manually.

Wireless device 402, 404, 406 profiles are created and preferably maintained in a subscriber information database 614, which is preferably accessed by the registration system 518. The scheduler 610 is preferably based on subscriber configuration and activity contained in the subscriber information database 614. In addition to containing information pertaining to the user specified preferred delivery method (e.g., manual or predefined times), the subscriber information database 614 also preferably contains information pertaining to subscribers' POP and/or IMAP e-mail account such as: user name/identification, user password, user e-mail address, user display name, server name, etc. The subscriber profiles in the subscriber information database 614 are preferably accessible at least via the servers 512, the agent gateways 504, and the Internet 506.

In operation, the scheduler 610 notifies the download manager 620 via the device action manager 640 at the proper time for each wireless device 402, 404, 406. The scheduler 610 preferably accesses the subscriber information database 614 to determine the user specified download time(s) for each respective wireless device 402, 404, 406. Upon receiving such notification, the scheduler 610, preferably uses a scheduling algorithm and device activity and configuration information contained in subscriber database 614 to decide on the action that needs to be taken. Once the action is determined, the scheduler 610 notifies the device action manager 640.

The system 500, in a preferred embodiment, does not store messages permanently since virtually all POP and IMAP servers 512 provide storage for holding an unlimited number of messages for an unlimited period of time. The agent gateways 504 thus preferably store messages downloaded from a server 512 for a limited time period (e.g., 72 hours). When wireless devices 402, 404, 406 check for new mail on a server 512, any new messages on a server 512 must be differentiated from old messages (i.e., messages already downloaded to a wireless device 402, 404, 406), as the agent gateway 504 does not download all messages residing on a server 512, but only those that have not yet been downloaded. To solve this problem, the system 500 can to store and access some minimal “lookup” information about all messages on the servers 512.

As previously discussed, the message lookup manager 620 is therefore preferably optimized for performance for worst case scenarios (e.g., 1000 messages in mailbox on server 512 with only one being a new message that needs to be downloaded). The lookup information database 628 stores an identifier associated with each user (e.g., a user ID) and a message identifier that identifies each message (which is unique across various sessions for a given user) for each user that has been downloaded. Database 628 is generally useful across various sessions of the service, but within a given session, using database 628 would have an adverse impact on performance. Therefore, in a preferred embodiment, a minimal, just in time, in-memory lookup information table 624 is provided. The lookup manager 620 is also responsible for deleting records from the lookup table and in-memory data structures when corresponding messages are deleted from the user's mailbox storage on server 512.

In a preferred embodiment, the lookup manager 620 will access, for example, a message ID associated with each user message stored on an e-mail server 512. Each message ID associated with each user is unique. That is, the combination of the user ID and the message ID is unique. The lookup manager 620 accesses the message IDs associated with each message on an e-mail server 512, compares those IDs with the ID's of messages that have already been downloaded to the proxy server 505, and downloads only those messages associated with message IDs that have not already been downloaded. In an alternative embodiment, when using IMAP, the lookup manager may simply access the last message ID downloaded and, in accordance with the IMAP, download from an e-mail server 512 those messages having a higher message ID number than the last message ID number downloaded. If desired, lower numbers can also be utilized to number messages that have not been downloaded.

The database lookup manager 622 thus accesses, for example, a message ID or other unique message identifier associated with each stored message on a server 512, and compares these messages with the message IDs of messages already downloaded to the agent gateway 502, as provided by the lookup info table 624. In a preferred embodiment, database 628 stores in a fixed medium (e.g., a hard drive, CD-ROM, tape drive, and the like) the data contained in the lookup info table 624 in the event of a system 500 failure. The device queue 626, preferably resident in memory, maintains a list of wireless devices 402, 404, 406 for which action needs to be taken. For example, if ten wireless devices 402, 404, 406 have requested and/or are scheduled to check their messages on their respective servers 512 as determined by the scheduler 610, the database lookup manager 622 will access the device queue 626 to retrieve such information.

The message download manager 650 downloads new messages from servers 512 once new messages have been identified by the lookup manager 620. The download manager 650 waits for notifications from the scheduler 610 and the lookup manager 620. Once the input notifications are processed, the download manager 650 directs worker threads 660 as will be described herein.

Since the system 500 needs to connect to and communicate with various servers 512 in parallel, the preferred embodiment uses a multi-threaded approach. Hence, to create and optimally manage these threads a thread pool manager 654 is preferably used. Optionally, other implementations such as standard thread pool manager classes could equally be used. The thread pool manager 654 receives information from the device action manager 640, accesses the state of wireless device 402, 404, 406 from the device queue 658, and directs the worker threads 660 in downloading messages from a server 512 associated with the wireless device 402, 404, 406 under consideration in the device queue 658.

Regarding the worker threads 660, the Winsock (WINdows SOCKets) transport 664 is a standard application programming interface (API) between a Windows application and the TCP/IP protocol. Most TCP/IP stacks designed to run under Windows and most Windows software that communicates via TCP/IP is Winsock compliant. The Winsock routines are preferably implemented as a dynamic link library, and the WINSOCK.DLL file is included with the Windows operating system. The Winsock transport 664 is used to communicate between the download manager 650 and various servers 512.

The download protocol identifier 666 identifies which download protocol is used by the server (e.g., POP, IMAP, etc.). The connection handler 662 connects to a specific server 512 associated with the wireless device 402, 404, 406 currently in the device queue 658 and downloads any new message(s) identified by the message lookup manager 620, as previously described. The connection handler 662 also optionally identifies the type of connection to the server 512 (e.g., internet 506, dedicated line, virtual public network (VPN), etc.).

Messages downloaded from a server 512 are preferably stored in a raw message queue 630 via the output handler 668. The raw message queue is provided in a preferred embodiment since there will generally be differences between the processing speed of the download manager 650 and the message processor 670.

The message processor 670 retrieves messages (e.g., messages in server 512 format such as POP or IMAP) from the message queue 630, parses the messages, and creates a message object using the message interpreter 672. Once a message is retrieved from a given server 512, the message needs to be interpreted from the server 512 mail format (e.g., POP, IMAP, etc.), normalized to the Proxy server 505 message format, and stored in a database 630 for subsequent processing. The process of retrieving, normalizing, and storing a message will generally take longer than simply downloading the message. Therefore, the database 630 also serves as a raw message queue. The device action manager 640 maintains the state information of the message lookup manager 620 and user information associated with each wireless device 402, 404, 406 contained in the device queue 626.

Once the message is interpreted, it is normalized to the Proxy server 505 message format by the eLink^{SM} message normalizer 674, and stored in a database 630. After storing the message, the agent gateway 504 can transmit the message to the designated wireless device 402, 404, 406, and the raw message queue manager 630 is notified to remove message from its queue, each by the persistence and notification handler 676.

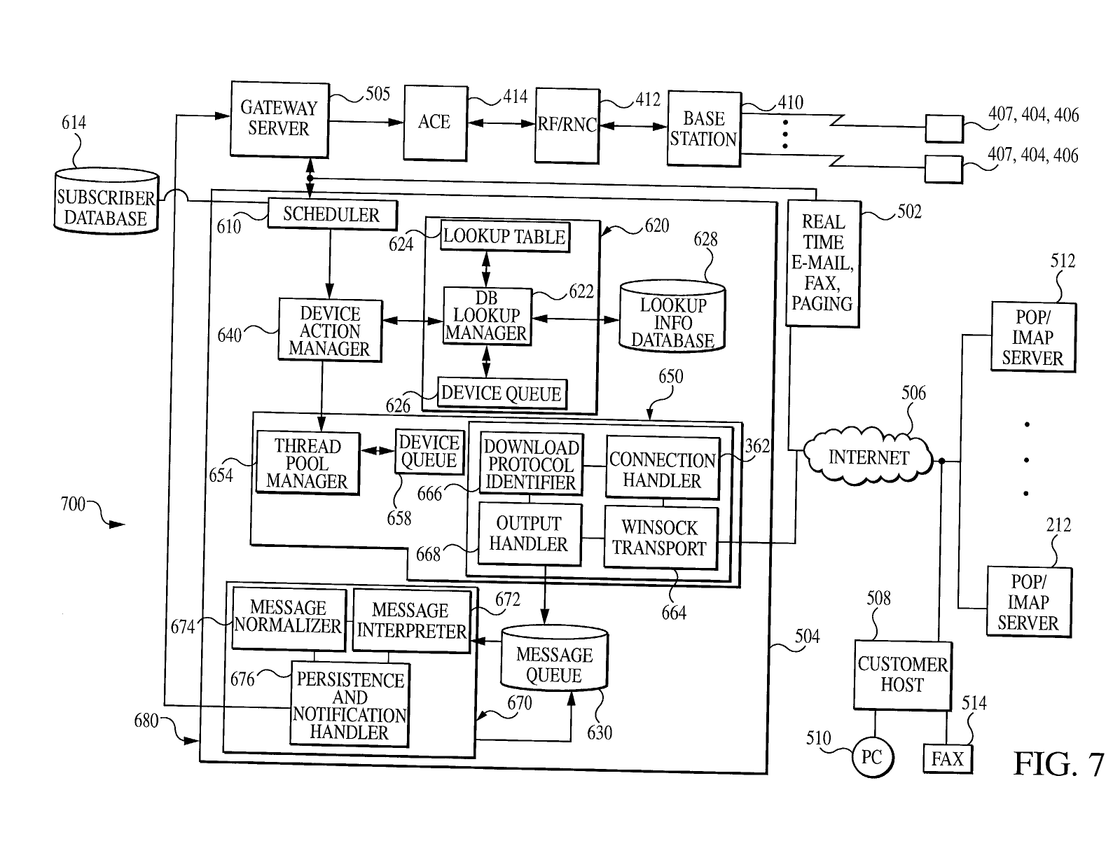

FIG. 7 shows an exemplary block diagram of the combination system 700. FIG. 7, which is similar to FIG. 5, shows the integrated architecture of the agent gateway 504. Specifically, the agent gateway 504 now shows the POP service architecture 600 as previously discussed with regard to FIGS. 6A and 6B. The integrated system 700 provides the functionality and advantages of real time and/or polled delivery of e-mail messages, faxing and paging as described heretofore.

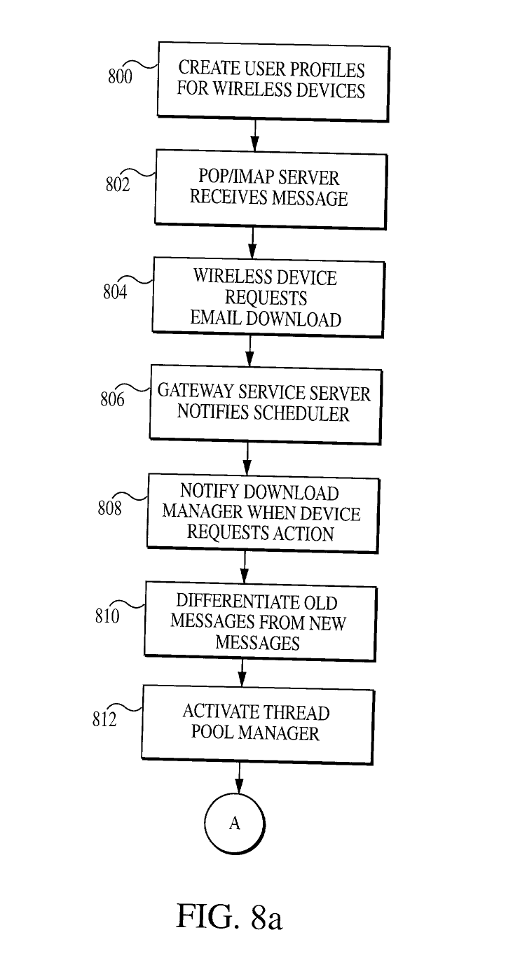

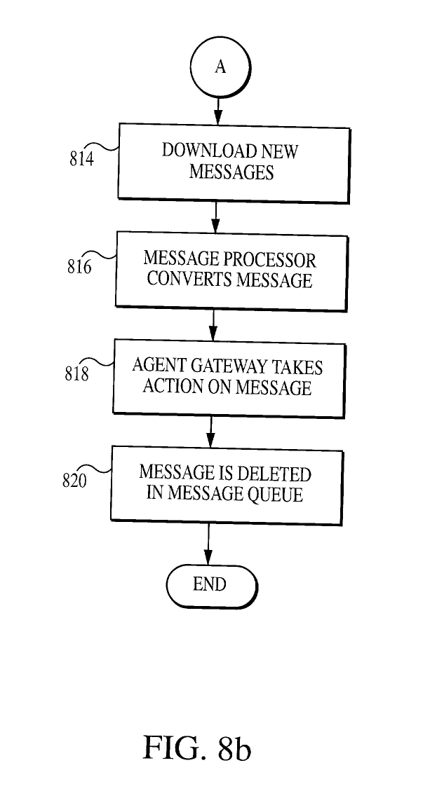

FIG. 8 is a flow chart illustrating the steps performed by the combination system 700 when a user uses a wireless device 402, 404, 406 to retrieve messages from a server 512. In step 800, wireless device 402, 404, 406 profiles are created and maintained in a subscriber database 614. The subscriber database 614 preferably contains information pertaining to the subscribers' POP and/or IMAP e-mail account(s) such as: user name/identification, user password, user e-mail address, user display name, server name, etc.

In step 802, one or more e-mail servers 512 receive one or more messages. The messages can be associated with one or more user's, where each user can have one or more e-mail accounts. As previously discussed, the messages stored on server 512 are preferably of a POP and/or IMAP format. In step 804, when a wireless device 402, 404, 406 is programmed or manually directed to retrieve messages stored on server 512, the agent gateway 504 is contacted via a base station 410, a RF/RNC 412, an ACE 414, and a gateway server as shown in FIG. 6. Alternatively, server 512 may transmit/broadcast messages directly or without the wireless device specifically requesting.

In step 806, the scheduler 610 stores the identification of each wireless device 402, 404, 406 that has requested a download in the device action manager 640. In step 808, the device action manager notifies the message download manager when each wireless device 402, 404, 406 has requested action.

In step 810, the thread pool manager 654 within the message download manager 650 is activated. As previously discussed, the thread pool manager 654 receives information from the device action manager 640, accesses the state of wireless device 402, 404, 406 from the device queue 658, and directs the worker threads 660 in downloading messages from a server 512 associated with the wireless device 402, 404, 406 under consideration in the device queue 658.

In step 812, the download manager 650, as previously discussed, utilizes the message lookup manager 620 to differentiate between any messages on a server 512 that have not been downloaded to an agent gateway 504. In step 814, the message download manager 650 downloads any new messages from a POP and/or IMAP server 512. While the message download manager 650 retrieves the computer messages from a server 512, the agent gateway 504 may continue to receive additional requests from other wireless devices 402, 404, 406 via the scheduler 610. In a preferred embodiment, user messages stored on server 512 are preferably identified, for example, by a message ID and/or a destination address of the computer messages, such as the user's e-mail addresses. As previously discussed, the user's account information may also include such information as a password associated with the user's account. The account information will also include when the wireless device wishes to receive messages (e.g., 9:00 AM and 5:00 PM).

Next, in step 816 the message processor 670 interprets (e.g., converts, formats, etc.) via the message interpreter 672 the message received from a POP/IMAP server to the agent gateway 504 message format. In step 818, an agent gateway 504 is notified to take action on this message by the persistence and notification handler 676. Finally, in step 820, the message in the raw message queue 630 is deleted by the persistence and notification handler 676.

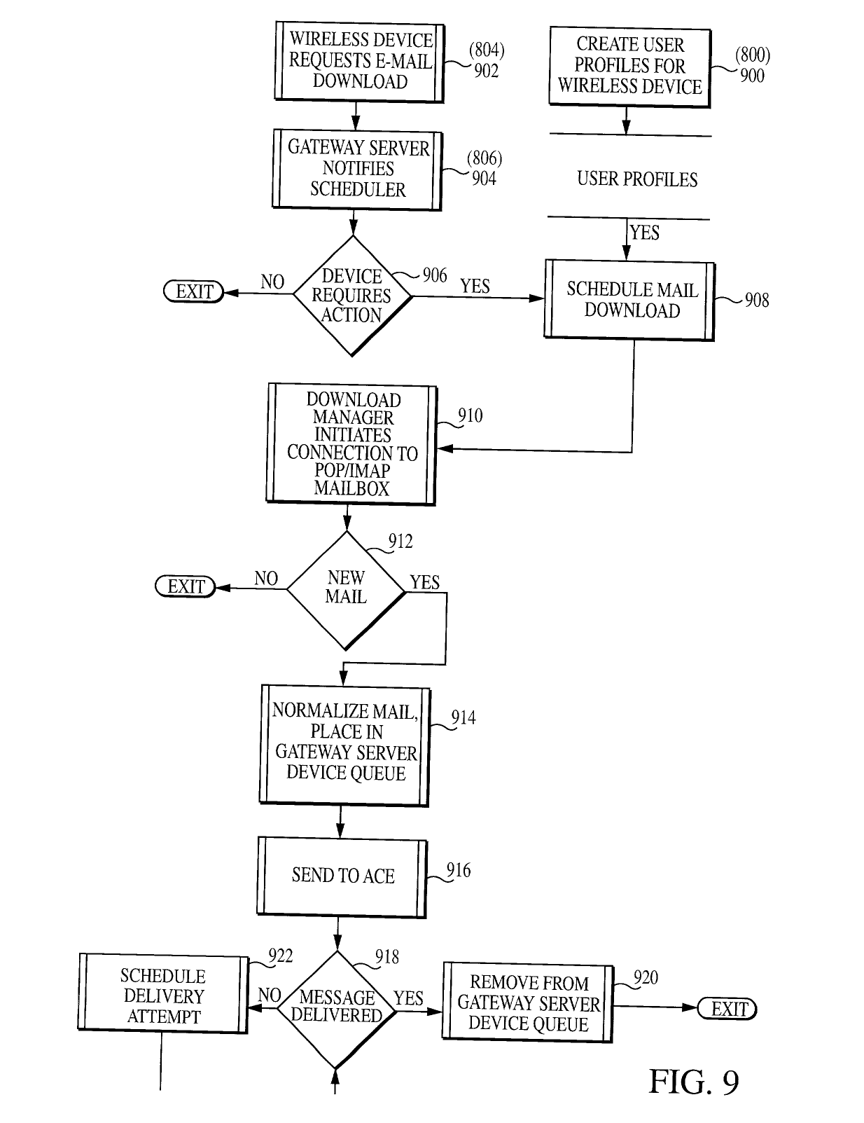

FIG. 9 is a more detailed flow chart containing decision logic illustrating the steps performed by the combination system 700 when a user uses a wireless device 402, 404, 406 to retrieve messages from a server 512. In step 900, wireless device 402, 404, 406 profiles are created and maintained in a subscriber database 614 as previously discussed.

In step 902, a wireless device 402, 404, 406 requests an e-mail download from a server 512. In step 904, the gateway server 505 notifies the scheduler 610 that a download has been requested. Upon determining that the device 402, 404, 406 requires action 906 (e.g., has requested a download), the scheduler 610 schedules the download 908.

At 910, the message download manager 650 initiates a connection to, for example, a POP or IMAP server 512 that contains the account from which messages are to be downloaded. If the message lookup manager 620 determines that the message(s) is/are new 912, the message interpreter 672 normalizes (e.g., converts, formats, etc.) the messages received from, for example, a POP or IMAP server 512 to, for example, the agent gateway 504 message format. The message processor 670 can then transmit the message(s) to, for example, a device queue of the gateway server 505. The gateway server 505 subsequently transmits the message(s) to an ACE 414 for subsequent transmission via the network 400 to the designated wireless device 402, 404, 406. If the message(s) has/have been delivered 918, the message is removed from, for example, a device queue of the gateway server 505. If the message has not been successfully delivered, another delivery attempt can be scheduled 922.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what we claim as new and desire to secure by Letters Patent is as follows:

1. A communications system for transmitting and/or receiving signals with at least two communication devices via a real time and/or a polled transmission, said communications system comprising:
at least one first gateway responsively communicable with at least a first communications device and at least a second communications device, wherein said at least one first gateway at least one of transmits and receives signals on a real time basis with the at least one first communications device and the at least one second communications device;
at least one second gateway responsively communicable with the at least one first communications device and at least a third communications device, wherein said at least one second gateway at least one of transmits and receives signals on a polled basis with the at least one first communications device and the at least one third communications device, said at least one first gateway and said at least one second gateway are operatively connectable to each other to perform the real time and the polled transmission based upon predetermined criteria, said at least one second gateway comprising:
a scheduler determining which of the at least one first communication devices are active;
a device action manager receiving notification from said scheduler and monitoring which of said at least one first communication devices have requested to download a message from said at least one third communications device;
a download manager receiving notification via said scheduler at which time messages associated with each of the at least one first communications device are to be downloaded;
a message lookup manager determining an identifier associated with each message associated with each of the at least one first communications device and selecting those messages that have not been downloaded from the at least one third communications device to the respective first communications device; and
a message processor for retrieving messages from the third communications device and transmitting the messages to the respective designated first communications device as determined by a selection system.

2. The system according to claim 1, wherein the predetermined criteria comprise an Internet domain name associated with each of the at least one first communications device and the at least one second communications device.

3. The system according to claim 2, wherein the Internet domain name comprises at least one of a name of an organization or a name of an individual combined with a top level domain name.

4. The system according to claim 3 wherein the top level domain names comprise: a) .com; b) .net; c) .org; d) .edu; e) .gov; f) .mil; and g) .int.

5. The system according to claim 1, wherein the at least one first communications device comprises a wireless messaging device, and wherein the predetermined criteria comprises a first identifier associated with at least said at least one first gateway, and said second communications device comprises a wireless messaging device, and wherein the predetermined criteria further comprises a second identifier associated with at least said at least one first gateway, wherein the at least one first communications device and the at least one second communications device transmit signals to each other via said at least one first gateway.

6. The system according to claim 5, wherein said signals comprise at least one of an electronic mail message, an electronic page, and a paging message.

7. The system according to claim 1, wherein the at least one first communications device is a wireless messaging device having a first identifier associated with said at least one first gateway and the at least one third communications device is an e-mail server storing messages for at least one e-mail account, each e-mail account having a second identifier associated therewith, wherein the at least one first communications device and the at least one third communications device transmit signals to each other via said first and second gateways, and wherein the predetermined criteria are respective identifiers associated with each of the at least one first communication device and the at least one third communication device.

8. The system according to claim 7 wherein the at least one third communications device is a post office protocol server.

9. The system according to claim 7 wherein the at least one third communications device is an internet messaging access protocol server.

10. The system according to claim 1, wherein the selection system allows a user to select at least one of the real time and polled transmission, wherein when t he user selects the polled transmission, the signals comprise at least one e-mail message that is retrieved from a specified e-mail account associated with the at least one third communications device and are transmitted to one of the at least one first communications device.

11. The system according to claim 10 wherein the user selects a name of the specified e-mail account via the selection system.

12. The system according to claim 11 wherein the user specifies a time at which the at least one e-mail message is transmitted from the at least one third communications device to the at least one first communications device.

13. The system according to claim 1 wherein said at least one second gateway further at least one of transmits and receives signals on a real time basis with the at least one first communication device and the at least one second communications device.

14. The system according to claim 13 wherein network load considerations determine whether said at least one first gateway or said at least one second gateway is used to transmit signals from the at least one first communications device to the at least one second communications device, wherein when system traffic and/or response time is above a predetermined threshold level said at least one second gateway is used.

15. The system according to claim 1 wherein the signals comprise a facsimile transmitted from the at least one first communications device to the at least one third communications device in real time via said at least one first gateway and said at least one second gateway.

16. The system according to claim 1 wherein said scheduler further determines the time at which each of the at least one first communications device are to receive a message.

17. The system according to claim 1 wherein said scheduler access es subscriber information from the selection system to determine user specified download times.

18. The system according to claim 1 wherein said download manager downloads messages subsequent to receiving an indication from said scheduler and said lookup manager.

19. The system according to claim 1 wherein said message processor converts the message format of the at least one third communications device to a message format of the at least one first communications device.

20. The system according to claim 1 wherein said lookup manager deletes a message record when a corresponding message is transmitted to the at least one first communications device.

21. The system according to claim 1 wherein each of said at least one first gateways have a common domain name associated therewith.

22. A communications system for transmitting and/or receiving signals with at least two communication devices via a real time and/or a polled transmission, said communications system comprising:
at least one first gateway responsively communicable with at least a first communications device;
at least one second gateway that at least one of transmits and receives signals on a polled basis with the at least one first communications device and at least a second communications device, said at least one first gateway and said at least one second gateway are operatively connectable to each other to perform polled transmission between the at least one first communications device and the at least one second communications device based upon predetermined criteria, said at least one second gateway comprising:
a scheduler determining which of the at least one first communication devices are active;
a device action manager receiving notification from said scheduler and monitoring which of said at least one first communication devices have requested to download a message from the at least one second communications device;
a download manager receiving notification via said scheduler at which time messages associated with each of the at least one first communications device are to be downloaded;
a message lookup manager determining an identifier associated with each message associated with each of the at least one first communications device and selecting those messages that have not been downloaded from the at least one second communications device to the respective first communications device; and
a message processor for retrieving messages from the second communications device and transmitting the messages to the respective first communications device as determined by a selection system.

23. The system according to claim 22, wherein the predetermined criteria comprise an Internet domain name associated with each of the at least one first communications device and the at least one second communications device.

24. The system according to claim 22, wherein the Internet domain names comprise at least one of a name of an organization or a name of an individual combined with a top level domain name.

25. The system according to claim 24 wherein the top level domain names comprise: a) .com; b) .net; c) .org; d) .edu; e) .gov; f) .mil; and g) .int.

26. The system according to claim 25, wherein said signals comprise at least one of an electronic mail message, an electronic page, and a paging message.

27. The system according to claim 22, wherein the at least one first communications device is a wireless messaging device having a first identifier associated with said at least one first gateway and the at least one second communications device is an e-mail server storing messages for at least one e-mail account, each e-mail account having a second identifier associated therewith, wherein the at least one first communications device and the at least one second communications device transmit signals to each other via said first and second gateways, and wherein the predetermined criteria are respective identifiers associated with each of the at least one first communication device and the at least one second communication device.

28. The system according to claim 27 wherein the at least one second communications device is a post office protocol server.

29. The system according to claim 27 wherein the at least one second communications device is an internet messaging access protocol server.

30. The system according to claim 22, wherein the selection system allows a user to select at least one of: a) a real time transmission between the at least one first communication device and at the least second communication device, and ii) the polled transmission, wherein the signals comprise at least one e-mail message that is retrieved from a specified e-mail account associated with the at least one second communications device and are transmitted to one of the at least one first communications device.

31. The system according to claim 30 wherein the user selects a name of the specified e-mail account via the selection system.

32. The system according to claim 31 wherein the user specifies a time at which the at least one e-mail message is transmitted from the at least one second communications device to the at least one first communications device.

33. The system according to claim 22 wherein said scheduler further determines the time at which each of the at least one first communications device are to receive a message.

34. The system according to claim 22 wherein said scheduler accesses subscriber information from the selection system to determine user specified download times.

35. The system according to claim 22 wherein said download manager downloads messages subsequent to receiving an indication from said scheduler and said lookup manager.

36. The system according to claim 22 wherein said message processor converts the message format of the at least one second communications device to a message format of the at least one first communications device.

37. The system according to claim 22 wherein said lookup manager deletes a message record when a corresponding message is transmitted to the at least one first communications device.

38. The system according to claim 22 wherein each of said at least one first gateways have a common domain name associated therewith.

39. A method of transmitting and/or receiving signals with at least two communication devices via a real time and/or a polled transmission, said method comprising the steps of:
determining based upon predetermined criteria whether the signals are to be transmitted in real time or on a polled basis; and
transmitting, upon determining that the signals are to be transmitted in real time, the signals from at least a first communications device to at least a second communications device via either a first gateway or a second gateway, and transmitting, upon determining that the signals are to be transmitted on a polled basis, the signals from at least a third communications device to at least the at least one first communications device via the first gateway and the second gateway.

40. The method according to claim 39 wherein the predetermined criteria is one of a) an identifier associated with the at least one first communications device and an identifier associated with the at least one second communications device, or b) an identifier associated with the at least one first communications device and an identifier associated with the at least one third communications device.

41. The method according to claim 40, wherein the identifier comprises an Internet domain name comprising at least one of a name of an organization or a name of an individual combined with a top level domain name.

42. The method according to claim 40 wherein the top level domain names comprise: a) .com; b) .net; c) .org; d) .edu; e) .gov; f) .mil; and g) .int.

43. The method according to claim to claim 39 wherein the signals comprise at least on of an electronic mail message, an electronic page, and a paging message.

44. The method according to claim 39 wherein in a polled transmission the at least one first communication device is a wireless device and the at least one third communications device is a server.

45. The method according to claim 44 wherein the server is a post office protocol server.

46. The method according to claim 44 wherein the server is an internet messaging access protocol server.

47. A method of transmitting and/or receiving signals with at least two communication devices via a real time and/or a polled transmission, said method comprising the steps of:
determining based upon predetermined criteria whether the signals are to be transmitted in real time or on a polled basis; and
transmitting, upon determining that the signals are to be transmitted in real time, the signals from at least a first communications device to at least a second communications device via either a first gateway or a second gateway, and transmitting, upon determining that the signals are to be transmitted on a polled basis, the signals from at least a third communications device to the at least one first communications device via the first gateway and the second gateway, the second gateway performing the steps of:
determining which of the at least one first communications device is active;
monitoring which of the at least one first communications device has requested to download a message from the at least one third communications device;
monitoring when messages associated with each of the at least one first communications device are to be downloaded;
recognizing an identifier associated with each message associated with each of the at least one first communications device and selecting those messages that have not been downloaded from the at least one third communications device to the at least one first communications device; and
retrieving messages not yet downloaded from the at least one third communications device and transmitting at least one message to a designated one of the at least one first communications device.

48. The method according to claim 47 wherein the predetermined criteria is one of a) an identifier associated with the at least one first communications device and an identifier associated with the at least one second communications device, or b) an identifier associated with the at least one first communications device and an identifier associated with the at least one third communications device.

49. The method according to claim 48, wherein the identifier comprises an Internet domain name comprising at least one of a name of an organization or a name of an individual combined with a top level domain name.

50. The method according to claim 49 wherein the top level domain names comprise: a) .com; b) .net; c) .org; d) .edu; e) .gov; f) .mil; and g) .int.

51. The method according to claim to claim 49 wherein the signals comprise at least one of an electronic mail message, an electronic page, and a paging message.

52. The method according to claim 49 wherein in a polled transmission the at least one first communication device is a wireless device and the at least one third communications device is a server.

53. The method according to claim 52 wherein the server is a post office protocol server.

54. The method according to claim 52 wherein the server is an internet messaging access protocol server.

55. The method according to claim 47, wherein the at least one first communications device comprises a wireless messaging device, the second communications device comprises a wireless messaging device, and the predetermined criteria comprise an identifier associated with the at least one first gateway.

56. The method according to claim 55, wherein said signals comprise at least one of an electronic mail message, an electronic page, and a paging message.

57. The method according to claim 47, wherein the at least one first communications device is a wireless messaging device having a first identifier associated with said at least one first gateway and the at least one third communications device is an e-mail server storing messages for at least one e-mail account, each e-mail account having a second identifier associated therewith, wherein the at least one first communications device and the at least one third communications device transmit signals to each other via said first and second gateways, and wherein the predetermined criteria are respective identifiers associated with each of the at least one first communication device and the at least one third communication device.

58. The method according to claim 57 wherein the at least one third communications device is a post office protocol server.

59. The method according to claim 57 wherein the at least one third communications device is an internet messaging access protocol server.

60. The method according to claim 47, further comprising the step of selecting at least one of the real time and polled transmission, wherein when a user selects the polled transmission, the signals comprise at least one e-mail message that is retrieved from a specified e-mail account associated with the at least one third communications device and are transmitted to one of the at least one first communications device.

61. The method according to claim 60 wherein the user specifies a time at which the at least one e-mail message is transmitted from the at least one third communications device to the at least one first communications device.

62. The method according to claim 47 wherein said at least one second gateway further at least one of transmits and receives signals on a real time basis with the at least one first communication device and the at least one second communications device.

63. The method according to claim 62 wherein network load considerations determine whether said at least one first gateway or said at least one second gateway is used to transmit signals from the at least one first communications device to the at least one second communications device, wherein when system traffic and/or response time is above a predetermined threshold level said at least one second gateway is used.

64. The method according to claim 47 further comprising the step of converting the message format of the at least one third communications device to a message format of the at least one first communications device.

65. The method according to claim 64 further comprising the step of deleting a message record when a corresponding message is transmitted to the at least one first communications device.
